(19) United States
(12) Patent Application Publication
(10) Pub. No.: US 2019/0187040 A1
(43) Pub. Date: Jun. 20, 2019

(54) Determining Fluid Reservoir Connectivity and Content Using Functionalized Nanowire Probes

(71) Applicant: The Regents of the University of California, Oakland, CA (US)

(72) Inventors: Paul S. Weiss, Los Angeles, CA (US); Anne M. Andrews, Los Angeles, CA (US); Andrea L. Bertozzi, Santa Monica, CA (US); Stanley J. Osher, Pacific Palisades, CA (US)

(73) Assignee: The Regents of the University of California, Oakland, CA (US)

(21) Appl. No.: 16/284,861

(22) Filed: Feb. 25, 2019

Related U.S. Application Data
(63) Continuation-in-part of application No. 15/308,049, filed on Oct. 31, 2016.
(60) Provisional application No. 62/634,755, filed on Feb. 23, 2018.
(60) Provisional application No. 61/988,808, filed on May 5, 2014.

(51) Int. Cl. G01N 15/08; G01N 15/06; G01N 15/14

(52) U.S. Cl. CPC G01N 15/0806; G01N 2015/0038; G01N 15/1463; G01N 15/06

(57) ABSTRACT

Systems and methods of fabricating and functionalizing patterned nanowire probes that are stable under fluid reservoir conditions and have imageable patterns are provided. Additional embodiments possess functionalized molecular groups to collect content data of desired chemical species from a fluid reservoir in order to detect even highly dilute quantities of the desire chemical species in the reservoir. Optical imaging and deconstruction methods and systems are also provided that are capable of determining the distribution of nanowires of a particular pattern to determine the mixing between or leakage from fluid reservoirs.

### RELATED APPLICATIONS

This application claims priority to U.S. Provisional Application No. 62/634,755, entitled “Determining Fluid Reservoir Contents and Flow Configuration Using Functionalized Nanowire Probes” to Weiss et al., filed Feb. 23, 2018, the disclosure of which is incorporated herein by reference in its entirety.

This application claims priority as a continuation-in-part of U.S. application Ser. No. 15/308,049, entitled “Determining Fluid Reservoir Connectivity Using Nanowire Probes” to Weiss et al., filed Oct. 31, 2016, which is a national stage entry of Application No. PCT/US2015/029173, filed May 15, 2015, which claims priority to U.S. Provisional Application No. 61/988,808, filed May 15, 2014, the disclosures of which are incorporated herein by reference in their entirety.

### FIELD OF THE INVENTION

The present disclosure is directed to methods and systems for monitoring and testing underground fluid reservoirs; and more particularly to methods and systems for monitoring and testing underground wells and tanks using imageable nanowires.

### BACKGROUND

An underground reservoir is an underground cavity, formation or tank that contains a fluid medium. A common example of such a reservoir is a well, which is a boring into the Earth that is designed to bring up a substance, such as water or petroleum oil hydrocarbons to the surface. In fields of such underground reservoirs, it can be important to know whether two reservoirs are fluidly interconnected and to what extent the connectivity exists. In other words, it may be important to understand the contents of each of the reservoirs and whether or not contaminants have been introduced in one or more of the reservoirs. In other circumstances it is important to know if a container is leaking into its surroundings. Such connectivity can be difficult to determine, and so a need exists to develop systems and methods that enable the determination of the connectivity between any of a plurality of wells and enable the determination of the content distribution in wells.

### BRIEF SUMMARY

The present disclosure provides embodiments directed to systems and methods for detecting underground connections between or leakage from reservoirs and for detecting the content of underground reservoirs that may be interconnected via distinctly patterned functionalized nanowires or microwires that are stable under the conditions often encountered in underground reservoirs such as oil and gas wells, using imaging methods and algorithms to automate the determination of statistically significant numbers of differently encoded imaging patterns.

In some embodiments, a nanowire probe system includes at least one probe population formed of a plurality of nanowires, the population of nanowires having a distinct imageable pattern associated therewith, the distinct imageable pattern associated with the population being formed on each of the plurality of nanowires of said population; and wherein the nanowires are comprised of a plurality of segments disposed adjacent each other along the longitudinal axis of the nanowire, the plurality of segments being formed from different materials having an imageable contrast therebetween, the imageable contrast between the different segments forming the imageable pattern.

In a further embodiment, the nanowire probe system includes at least two probe populations each formed of a plurality of nanowires, each population of nanowires having a distinct imageable pattern associated therewith, the distinct imageable pattern associated with the population being formed on each of the plurality of nanowires of the population.

In another embodiment, the plurality of nanowires in each population are formed of at least two sizes.

In a still further embodiment, the outer surface of each of the nanowires is functionalized with a plurality of functional groups configured to prevent agglomeration of the nanowires.

In still another embodiment, the plurality of functional groups does not obscure the imageable pattern.

In a yet further embodiment, an encapsulation layer is disposed on the outer surface of each of the nanowires, and the encapsulation layer is functionalized with a plurality of functional groups configured to prevent agglomeration of the nanowires.

In yet another embodiment, the plurality of functional groups and the encapsulation layer do not obscure the imageable pattern.

In a further embodiment again, the outer surface of each of the nanowires is functionalized with molecular groups to collect content data of a desired chemical species.

In another embodiment again, the imageable pattern is identifiable using a video imagery technique selected from the group consisting of computer vision and wavelet-based image processing.

In a further additional embodiment, at least one of the plurality of segments comprises nanoscale structures to reflect desired color patterns.

In another additional embodiment, a method of determining reservoir content includes introducing at least one probe population formed of a plurality of nanowires into a fluid medium in at least one fluid reservoir such that a mixture of nanowires and fluid medium is formed within the at least one fluid reservoir, the probe population having a distinct imageable pattern and a functionalized molecular group associated therewith, where the distinct imageable pattern associated with the population being formed on each of the plurality of nanowires of said population, and where the functionalized molecular group associated with the population function to collect content data of a desired chemical species in the at least one fluid reservoir; obtaining a sample of the mixture from at least one of the at least one fluid reservoir; imaging the sample; processing the imaged sample using a signal processor to quantitatively determine the concentration of the at least one probe population disposed within the sample, wherein the concentration of the at least one probe population indicates a flow from the at least one fluid reservoir, and wherein the signal processor is programmed with an automated algorithm and capable of differentiating the distinct imageable patterns associated with each population of nanowires; and detecting the desired chemical species from the functionalized molecular group associated with the nanowires in the sample.

In a still yet further embodiment, the method further includes introducing at least two probe populations each formed of a plurality of nanowires into a plurality of fluid reservoirs, where each of the at least two probe populations is introduced into a separate fluid reservoir in the plurality of fluid reservoirs such that a mixture of nanowires and fluid medium is formed within each fluid reservoir in the plurality of fluid reservoirs, where each population of nanowires having a distinct imageable pattern associated therewith, the distinct imageable pattern associated with the population being formed on each of the plurality of nanowires of said population; obtaining a sample of the mixture within each of the plurality of fluid reservoirs; imaging the samples from each of the plurality of fluid reservoirs; and processing the imaged samples using a signal processor to quantitatively determine the concentration of each of the at least two probe populations disposed within the samples, wherein the concentration of each of the at least two probe populations indicates a flow from the fluid reservoir in which each of the at least two probe populations was introduced, and wherein the signal processor is programmed with an automated algorithm and capable of differentiating the distinct imageable patterns associated with each population of nanowires.

In still yet another embodiment, the plurality of nanowires in each population are formed of at least two sizes.

In a still further embodiment again, the nanowires are comprised of a plurality of segments disposed adjacent each other along the longitudinal axis of the nanowire.

In still another embodiment again, at least two of the segments are formed from different materials having an imageable contrast therebetween, the imageable contrast between the different segments forming the imageable pattern.

In a still further additional embodiment, the outer surface of each of the nanowires is functionalized with a plurality of functional groups configured to prevent agglomeration of the nanowires.

In still another additional embodiment, the plurality of functional groups do not obscure the imageable pattern.

In a yet further embodiment again, an encapsulation layer is disposed on the outer surface of each of the nanowires.

In yet another embodiment again, the encapsulation layer is functionalized with a plurality of functional groups configured to prevent agglomeration of the nanowires.

In a yet further additional embodiment, the encapsulation layer and the plurality of functional groups do not obscure the imageable pattern.

In yet another additional embodiment, the imageable pattern is optically imageable and wherein the imaging comprises a video imagery technique selected from the group consisting of computer vision and wavelet-based image processing.

In a further additional embodiment again, the processing comprises automatically sorting the images from the sample by a processing technique selected from the group consisting of wavelet Gizburg-Landau regularization, spectral analysis of large Hermitian matrices, and modularity optimization.

In another additional embodiment again, the method further includes deconstructing and or reconstructing the imaged mixture sample using an image processing technique selected from the group consisting of total variation restoration, cartoon texture decomposition, and nonlocal TV reconstruction.

In a still yet further embodiment again, the sampling and imaging occurs within the flow from the at least one fluid reservoir.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure, wherein:

FIG. 1a provides a schematic of a method of detecting underground connections between fluid reservoirs in accordance with embodiments of the invention.

FIG. 1b provides a schematic of a method of detecting leakage from a fluid reservoir in accordance with embodiments of the invention.

FIGS. 2a and 2b provide schematics of nanowire probes in accordance with embodiments of the invention.

FIGS. 2c and 2d provide schematics of nanowire probes having different dimensional characteristics in accordance with embodiments of the invention.

FIGS. 3a and 3b provide schematics of functionalized nanowire probes in accordance with embodiments of the invention.

FIG. 4a provides a schematic of a process for forming nanowire probes in accordance with embodiments of the invention.

FIG. 4b provides a schematic of a process for forming a pattern on a nanowire in accordance with embodiments of the invention.

FIG. 5 provides an optical micrograph of exemplary striped metal nanowires in accordance with embodiments of the invention.

FIG. 6 provides a schematic of a process for imaging nanowire probe patterns in accordance with embodiments of the invention.

FIG. 7a provides real time tracking from 30-Hz video imagery using 2D bar codes in accordance with embodiments of the invention.

FIG. 7b provides results of bar code deconvolution using Wavelet Gizburg-Landau regularizer and the Haar basis in accordance with embodiments of the invention.

FIG. 7c provides images from the MNIST database of handwritten digits in accordance with embodiments of the invention.

FIG. 8 provides raw scanning tunneling microscope image analyzed automatically to identify the positions and identities of every silicon and hydrogen atom present, with atomic resolution in accordance with embodiments of the invention.

### DETAILED DESCRIPTION

The present disclosure may be understood by reference to the following detailed description, taken in conjunction with the drawings as described below. It is noted that, for purposes of illustrative clarity, certain elements in various drawings may not be drawn to scale.

In accordance with the provided disclosure and drawings, systems and methods of fabricating and functionalizing patterned nanowires that are stable under underground reservoir conditions, having unique wavelength imageable contrast, including some embodiments having surface functionality imparted thereon so that uniform or serial functionalization can be used are provided. Along with these nanowires, optical imaging methods and systems are provided, which are capable of determining the distribution of nanowires having different patterns to determine the mixing between or leakage from fluid reservoirs.

The problem of tracing flowing reservoirs, and particularly in underground reservoirs where access is limited has long been a problem and a number of solutions have been proposed. (See, e.g., U.S. Pat. No. 4,755,469 or WO2011084656A1, the disclosures of which are incorporated herein by reference.) Most conventional systems for studying flow into and out of underground formations require the use of radioisotopes. (See, e.g., USPN 507771) While these systems can be successfully implemented, they typically require the use of very sophisticated detection schemes such as laser spectroscopy, mass spectrometry or electrochemical cells. (See, e.g., WO2007/102023 or U.S. Pat. No. 8,596,354) Many such solutions even propose systems in which samples would be sent to a laboratory for analysis. (See, e.g., Alaskar et al., GRC Transactions, vol. 34 (2010)) So far no system for reservoir flow monitoring has been proposed that would allow for the automated determination of the statistical populations of various probes in real time.

Additionally, problems exist in detecting particular content of reservoirs, especially in underground reservoirs where access is limited, detecting the content requires various types of sampling methods to determine the content and/or level of contamination within a given reservoir. Current methods involve taking full samples of the medium within the well and performing chemical analysis that is known in the art. The current problems associated with taking actual fluid samples may result in inaccurate tests or false negative tests results. It can be difficult to obtain a sample large enough to fully detect the contaminants in mediums which contain highly diluted contaminants against larger backgrounds of other chemical species. Current methods may include injecting a Fluoro luminescence dyes that would be able to react to light and potentially indicate a level of contamination. These methods however involve the introduction of dyes and other potentially harmful elements into the reservoir.

### Probe Structure and Use

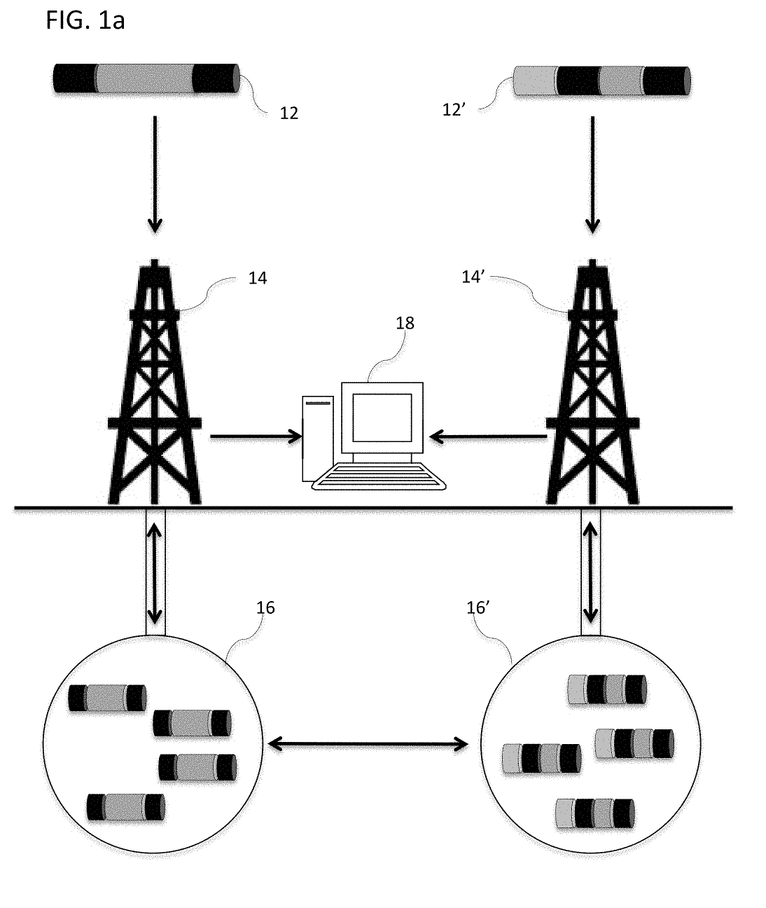

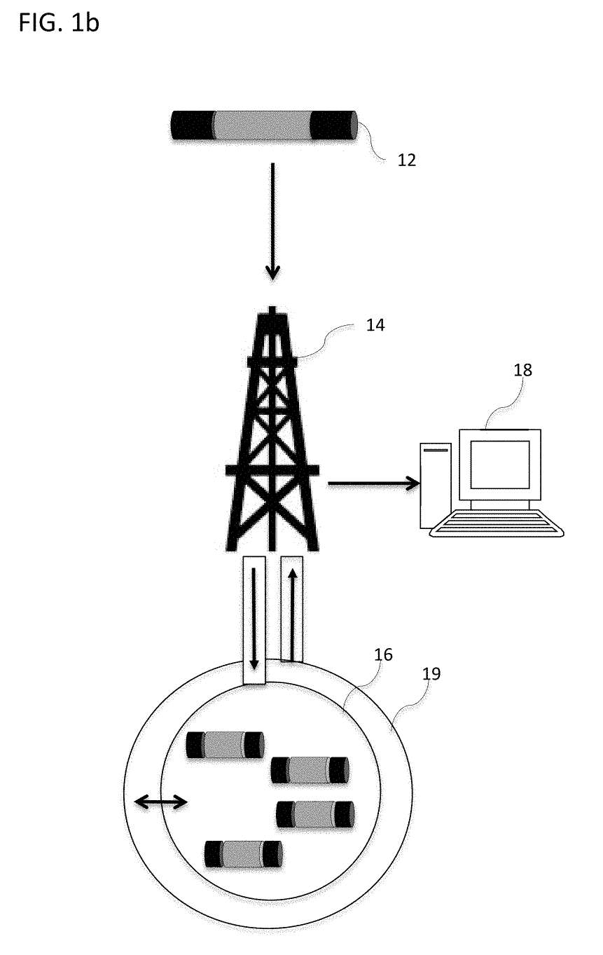

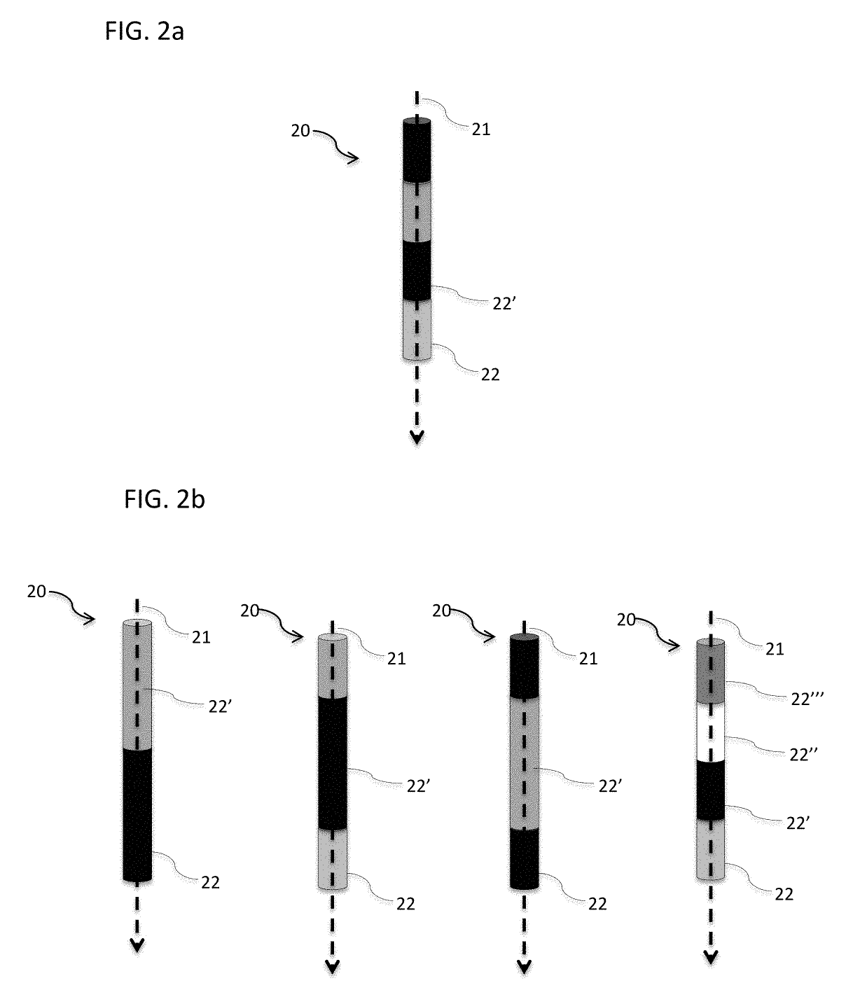

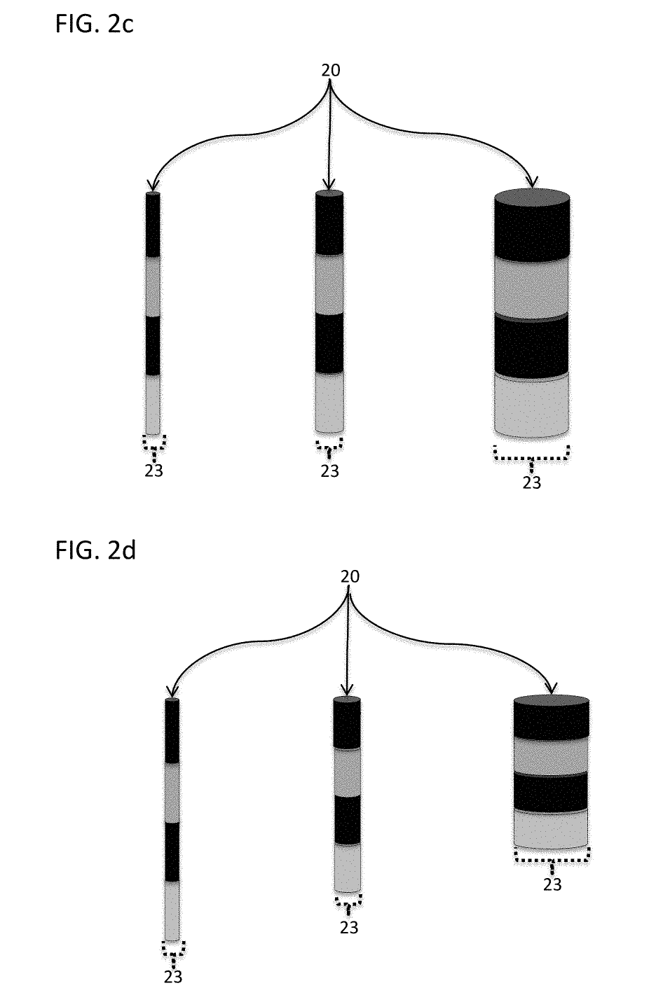

In many embodiments, methods are provided for the real-time monitoring of the flow, content and/or contamination level between two or more reservoirs that may also be interconnected. A schematic according to embodiments of such a system is provided in FIG. 1a. In embodiments, at least one batch of probes (12 & 12′) formed of nanowires having high-contrast optically identifiable patterns and/or chemical binding site patterns are loaded into at least one underground well (14 & 14′) such that the probes are introduced into an underground reservoir (16 & 16′). To test, interconnectivity, at least two batches of probes (12 & 12′) formed of nanowires having different high-contrast optically identifiable patterns and/or chemical binding site patterns are loaded into at least two underground wells (14 & 14′) such that the probes are introduced into the underground reservoirs (16 & 16′) to which the wells are fluidly interconnected. Once the probes are introduced into the reservoir(s), the well(s) is sampled at suitable intervals over a period of time and the samples analyzed using an automated optical monitoring device (18). The data thus supplied by the monitoring device provide information about the relative concentration of the various probes in each of the sampled wells and can be used to quantify the extent of mixing or flow between the wells. Systems similar to those illustrated in FIGS. 1a and 1b including nanowires of types illustrated in FIGS. 2a-2d are further illustrated in U.S. patent application Ser. No. 15/308,049, which is incorporated herein by reference.

Although the example schematic provided in FIG. 1a shows the use of the embodiments on two wells or underground reservoirs it will be understood that the technique described above can be used with any number or type of fluid reservoirs where there is a desire to determine either interflow or mixing between said reservoirs or the leakage of those reservoir(s) into their surroundings. For example, FIG. 1b provides a schematic according to embodiments of such an alternative system. In embodiments, a single batch of probes (12) formed of nanowires having a high-contrast optically identifiable pattern are loaded into a single well (14) such that the probes are introduced into the underground reservoir (16) to which the well is fluidly interconnected. Once the probes are introduced into the reservoir, the area of interest (19), such as, a surrounding fluid body or flow is sampled at suitable intervals over a period of time and the samples analyzed using an automated optical monitoring device (18). The data thus supplied by the monitoring device provide information about the concentration of the probes in the area of interest and can be used to quantify the extent of flow from the reservoir.

Exemplary embodiments of suitable fluid reservoir types include, for example, oil wells, water tables, underground or above ground storage tanks, etc. The requirements for use of the present system include a fluid medium into which the probes may be introduced (e.g., oil, water, etc.), a fluid pathway to introduce the probes into the reservoirs (e.g., a well head, pumping station, etc.), and a fluid pathway for sampling the fluid medium in the reservoirs (e.g., a pumping station, fluid sampling path, etc.). It should be understood that the same fluid pathway may be used for introducing and sampling the fluid medium. In many embodiments the sampling and/or introduction fluid path may also comprise the fluid path utilized for extraction of the fluid medium of the reservoir being monitored. In addition, although in some embodiments the probes are sampled external to the well or reservoir, in other embodiments, detectors could be permanently positioned in various locations within the reservoir or introduced within the reservoir to image the fluid medium in-situ.

The probes according to embodiments comprise nanowires or microwires, formed with imageable patterns disposed thereon. In many embodiments, as shown schematically in FIG. 2a the nanowires (20) comprise a plurality of segments (22 & 22′) of materials with contrasting imageable wavelengths formed along the longitudinal axis (21) of the nanowire. Such wavelengths are further taught in U.S. patent application Ser. No. 15/308,049, which is incorporated herein by reference. Although FIG. 2a shows a schematic of one embodiment of such a nanowire, it will be understood that any number and arrangement of segments and materials may be used such that an imageable pattern of contrasting segments is formed in the nanowire. As shown in FIG. 2b this includes the use of different numbers segments, different segment lengths and segments of more than two materials of varying contrast.

The nanowires may be formed of any material suitable for use under the particular fluid reservoir conditions to be monitored. In many embodiments the materials for the nanowire probes are chosen with the following requirements in mind: 1) that the materials be relatively stable, i.e., not subject to material degradation, under the conditions found in the fluid reservoir; and 2) that the materials allow for the formation of features having an optical contrast suitable for monitoring via optical imaging sampling techniques. Exemplary materials may include two or more semiconductors, metals, oxides, ceramics, polymers, mixtures thereof, etc. In some such embodiments the probes are comprised of nanowires formed of alternating segments of two of more different metals that create an imageable contrast, such as, for example, Au, Cu, Ag, Pt, etc. The imageable contrast may be between any two imageable wavelengths, for example, between two visible wavelengths or between UV, IR or a combination of visible, IR and UV wavelengths. In many embodiments, the contrasting wavelengths of the segments are all in the visible spectrum such that optical scanning systems such as those similar to conventional barcode scanning systems may be used. In some embodiments, the nanowire probes are made of materials that do not react or interact with the environment where they are to be placed. For example, an environment exhibiting magnetic characteristics, some ferrous or other magnetizable materials may aggregate and/or be removed from the internal volume of a reservoir. As such, various embodiments will use non-ferrous materials that do not exhibit magnetic or magnetizable properties.

In addition to the imageable contrasting segments that many of the nanowires may comprise, other functional characteristics may be desired beyond chemical content and flow connectivity, such as for example, determining location and placement of a certain quantity or disbursement of the nanowire probes. In accordance with many embodiments the alternating segments of metals will comprise nanoscale structures on the order of wavelengths that may be specifically selected to reflect desired colored patterns. In some embodiments the alternating segments may comprise plasmonic materials arranged to have one or more plasmonic resonances thereof, thus resonating at a desired color wavelength. The plasmonic resonances will produce an optical response that can be modeled in accordance with present teachings of plasmonic materials.

Utilizing nanowires with such alternate detection features may allow the optical imaging device to detect the desired number of plasmonic type nanowires within any given reservoir and may also be useful in determining flow rates etc. In many embodiments the nanowires containing such color reflection methods may further incorporate functional molecular concentrator groups such that multiple sampling operations can be achieved on the same level.

Although nanowire probes having identical diameters and lengths are shown in FIGS. 2a to 2b it should be understood that the diameters (FIG. 2c) and lengths (FIG. 2d) or both of the nanowires may also be varied such that the size of the pore or interconnections between the reservoirs may also be tested. The size (length and diameter) of the various probes may be chosen for the particular pore or interconnectivity size. With respect to the general dimensions of the nanowire/microwire probes, they may, in general take any suitable size so long as at least one dimension is between 1 nanometer and 100 microns.

### Probe Functionalization

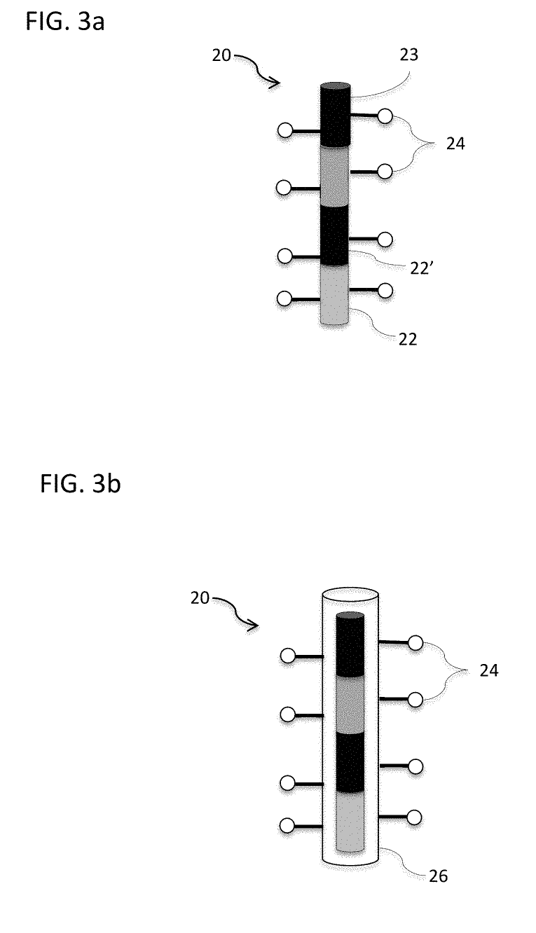

In order to disperse the nanowire probes within the reservoir and particularly to prevent agglomeration of the probes after production, the outer surfaces of the nanowire probes may be further functionalized. In some embodiments, as shown in FIG. 3a, the outer surface (23) of the nanowire probes (20) may be functionalized with monolayers of functional groups (24), such as, for example, hydrophobic thiolates. (See, e.g., Love, et al., Chem Rev, 105 (2005)) In many embodiments where functionalization is desired the materials of the segments (22 & 22′) may be selected such that a single functionalization chemistry will operate to functionalize all segments of the nanowire probes, although serial functionalization may also be used if a single uniform functionalization is unavailable. It should be understood that the functional groups of some embodiments do not have to survive in the reservoirs for the entire time that the probes are circulating within the reservoir so long as they survive at least during the initial introduction and dispersal of the probes into the reservoir.

In many embodiments the functional molecular groups will function to collect content data in the form of a concentrator thereby combining small amounts of data into a measureable quantity for detection. The concentrator function allows for the ability for the nanowires to capture and subsequently be tested for at least one desired chemical species, even if the desired chemical species are highly diluted against large backgrounds of other chemical species; thus requiring smaller amounts of detection wires within the fluid reservoirs. In certain embodiments, these concentrators will be capable of longevity within the reservoir such that the collected samples may be tested in a post extraction environment. Longevity of the molecular concentrators is critical to ensure the most effective sampling once the nanowire probes have been retrieved from the reservoir. In accordance with many embodiments the detected desired chemical species on the concentrators may be tested using any variety of chemical testing methods known in the art.

In other embodiments, where more robust functionalization is desired, as shown in FIG. 3b, an encapsulation layer (26) may be disposed about the nanowire probe (20) upon which the functional groups (24) may be further attached. For example, in some embodiments the encapsulation layer may comprise a refractory oxide, which may be further functionalized with a hydrophobic siloxane, for example. Functionalization through such an encapsulation layer allows for a more robust connection between functional group and probe and also allows for a single functional group substrate such that the segments of the nanowire probes may be formed with materials with disparate functional chemistries.

Regardless of the functional groups or encapsulation layers chosen to functionalize the probe nanowires, in many embodiments the materials are selected such that they are largely transparent, i.e., such that neither the functional nor encapsulation layers will interfere with the measurements of the imageable patterns formed on the probes.

Regardless of the functional groups or encapsulation layers chosen to functionalize the probe nanowires, in many embodiments the materials are selected such that they are largely transparent, i.e., such that neither the functional nor encapsulation layers will interfere with the measurements of the imageable patterns formed on the probes. In many embodiments the functional groups or encapsulation layers can be sufficiently thin to be effectively transparent.

### Probe Fabrication

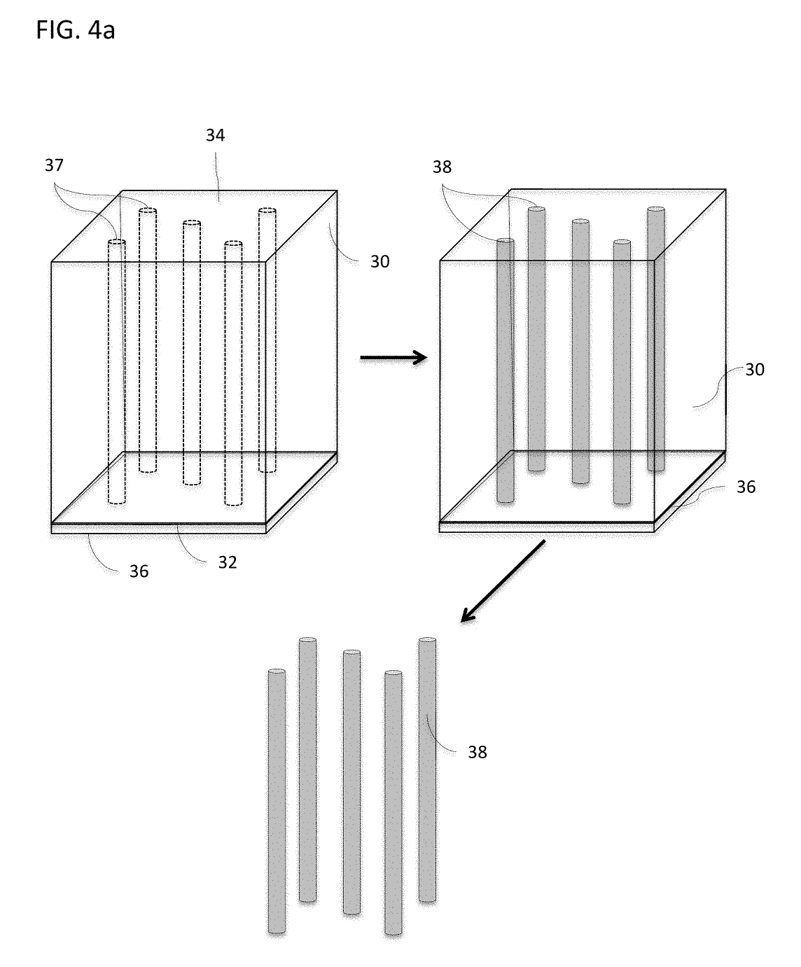

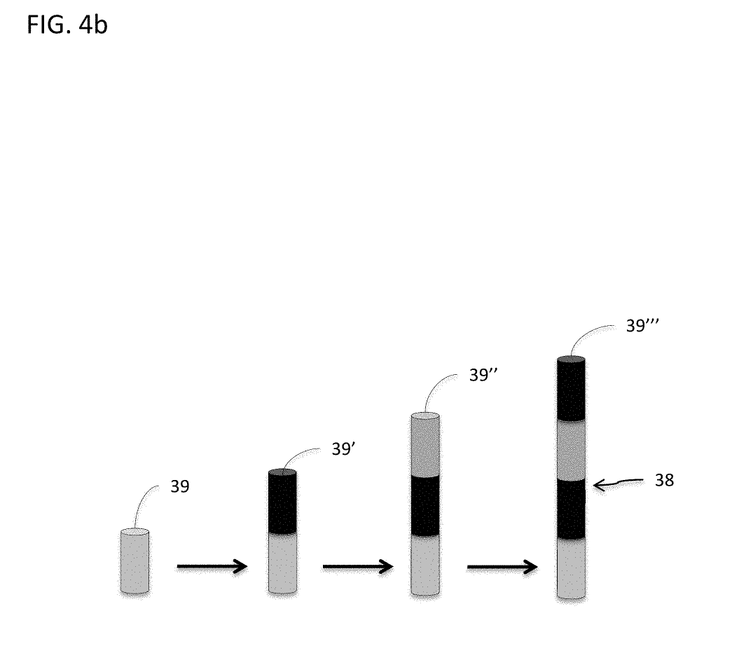

Embodiments are also directed to methods of forming nanowire probes. In many embodiments, as shown schematically in FIG. 4a, an electrochemical method may be used. In such a method electrochemical etching is used to fabricate an inert membrane (30) with first (32) and second surfaces (34), and having one or more pores (37) with diameter and length dimensions that correspond with the diameter and length dimensions of the desired nanowire probes. These pores (37) serve as templates for controlled nanowire growth. In particular, it has been shown that the pore size diameter may be determined and controlled by the etching conditions used to form the membranes while the length of the individual nanowire probes may be controlled by the thickness of the original membrane block. The membrane block itself may be formed of any suitable inert material, such as, for example, alumina.

During fabrication, one side of the membrane is covered with a conductive layer (36), such as, for example a metallic paint such Ag, Au or Pt. The nanowires (38) are then grown within the pores (37) by use of electrochemical deposition. In particular, the nanowire probes grown in accordance with embodiments of the methods are formed with stripes of controlled length by reductive desorption from a solution containing a salt of the material, such as a metal, to be deposited. (See, e.g., CR Martin, Science 266, 1961 (1994); D Routkevitch et al., Journal of Physical Chemistry 100, 14037 (1996); and SR Nicewarner-Pena et al., Science 294, 5540 (2001).) In embodiments, the solutions and thus metals may be changed in order to grow segments (39 to 39′″ of FIG. 4b) of different metals. In addition, in embodiments the integrated current at each step may be modified to alter the lengths of the different segments of the nanowire probe. Using a combination, therefore, of different solutions and different currents nanowires formed with different patterns of varying imageable contrast may be formed, as shown in FIG. 4b. After this controlled growth, as shown in FIG. 4a the membranes may then be dissolved to free the nanowires. If desired the nanowires may be further functionalized as described above and/or electron and optical microscopy may be further used for analysis and diagnostics of both the membranes and the nanowires.

In many embodiments, these systems and methods may be used to fabricate large numbers of nanowires. In particular, in some embodiments techniques for making membranes from large-area aluminum foil may be used to scale up production of the metal nanowires, as needed, and increased throughput may be tested by using flowing samples. (See, e.g., MH Lee, et al., Nano Letters 11, 3425 (2011); and WS Liao, et al., Journal of Physical Chemistry C 117, 22362 (2013).) These nanowires may be produced in populations of identical nanowires, where different batches may employ different imageable patterns to differentially “label” each of the reservoirs into which each population of nanowire probes are introduced.

### Probe Detection

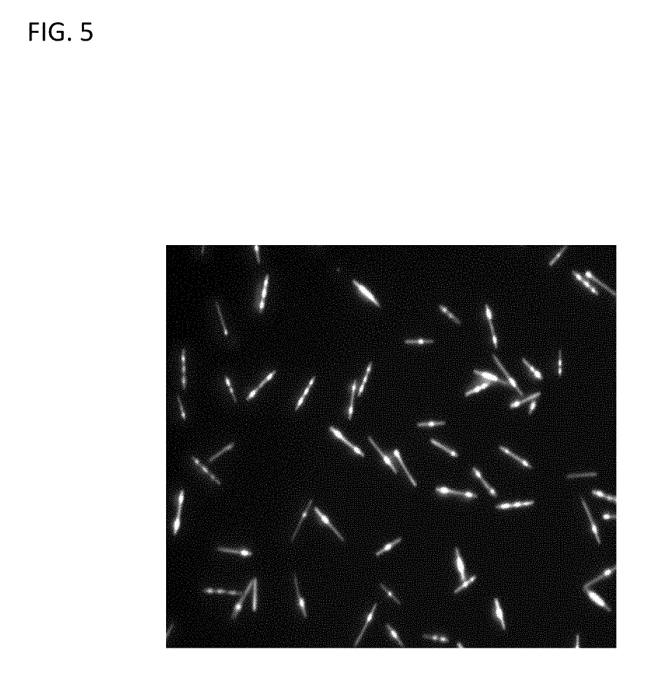

In embodiments, these systems may be used to produce nanowire probes formed, for example, with metal (such as, for example Au, Ag, Cu and Pt) semiconductor, polymer, or oxide striped nanowires that: 1) are stable under well conditions; 2) have a pattern with an imageable contrast; and 3) optionally either have sufficiently similar surface chemistry so that uniform or serial functionalization can be used or have an encapsulation layer that allows for such uniform or serial functionalization. An optical micrograph of a selection of different striped metal nanowires formed in accordance with such embodiments is provided as an example in FIG. 5.

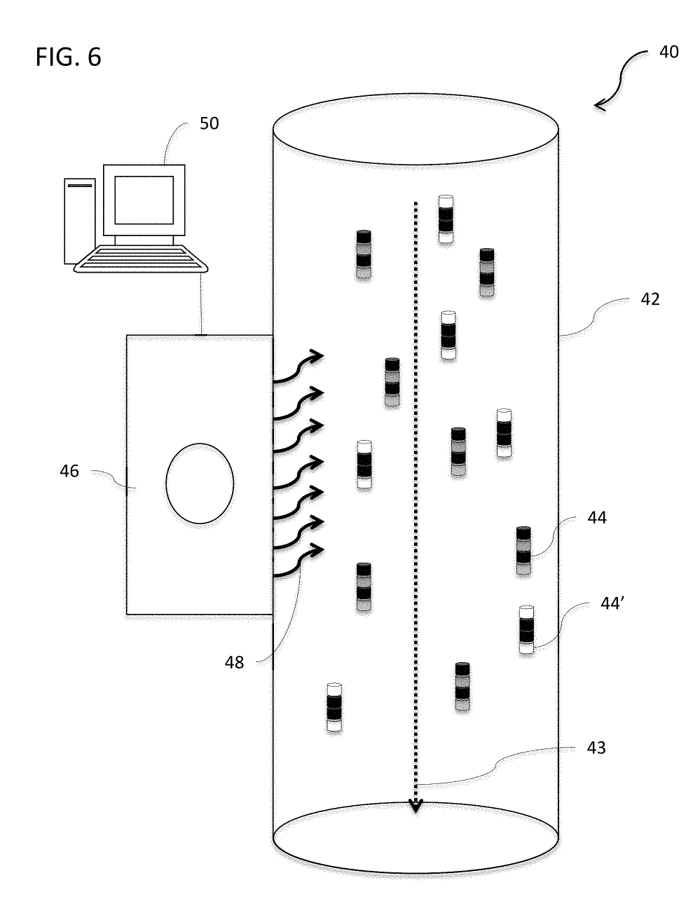

Some embodiments are also directed to optical imaging of populations of nanowires having different imageable patterns, including contrasting patterns and wavelength color patterns. A schematic of such a system (40) is shown in FIG. 6 and generally comprises an optical imager (46) disposed in imaging relation to a sample chamber or flow region (42) fluidly interconnected with a sample reservoir. In the case of a flow region a flow (43) of a fluid from a sample reservoir may be directed therethrough. The optical imager (46) is designed to emit and detect an imaging emission (48). The imaging emission is selected to be of a wavelength suitable for detecting the imageable patterns disposed on at least one nanowire probe (44 and 44′). In certain embodiments, the position of one or more nanowire/microwire probe with an imageable pattern (e.g., contrasting patterns or wavelength color patterns) will be determined using the optical imager.

Using such imaging methods, and utilizing sampling methods, embodiments will be directed to systems adapted to determine the flow or mixing between or leakage from sampled reservoirs. In many embodiments, a signal processor (50) programmed with automated algorithms and methods may also be provided to automatically determine the statistical distribution of the nanowire probes of different imageable patterns within the sampling population. As discussed, embodiments may incorporate static distributions or flow distributions (as shown in FIG. 6) for higher throughput.

In many embodiments, automated tracking and identification systems and methods may be used to identify the different imageable patterns (e.g., contrast and/or color patterns) from the sample of nanowire probes at a desired wavelength. Embodiments of such systems and methods may be adapted from systems designed to automatically track and identify barcodes using video imagery. In some embodiments such systems may utilize Intel's or others' computer vision software (contour searching function that is capable of identifying rectangles that bound features in the image and an iterative algorithm that identifies symbols such as bar codes). In other embodiments, a wavelet-based image processing metric with several applications including one- and two-dimensional bar code deblurring may also be used. (See, e.g., JA Dobrosotskaya and A L Bertozzi, IEEE Transactions on Image Processing 17, 657 (2008).) Such embodiments may also include automatic sorting algorithms that take images as input and sort them into like categories.

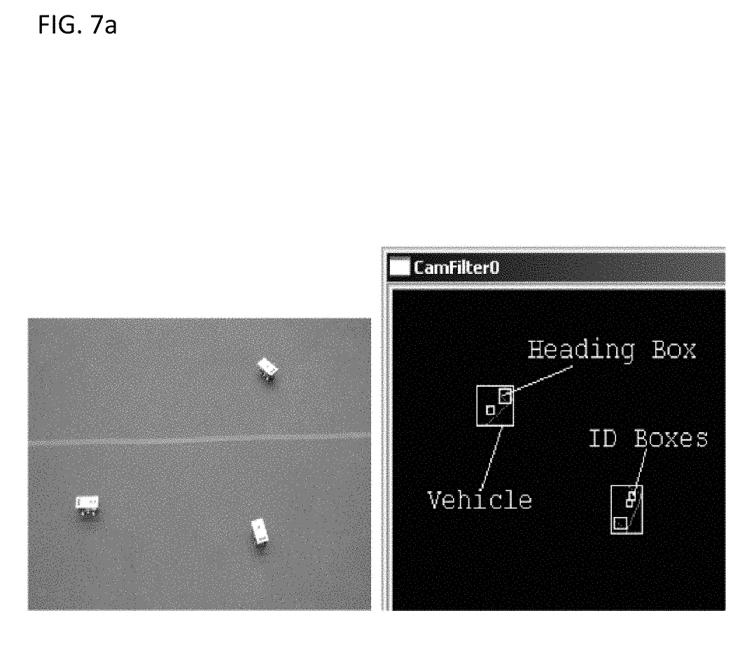

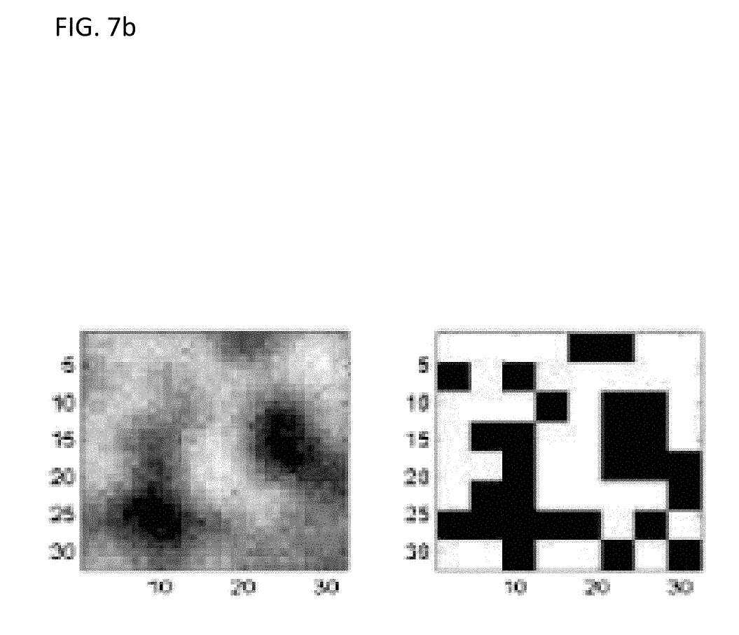

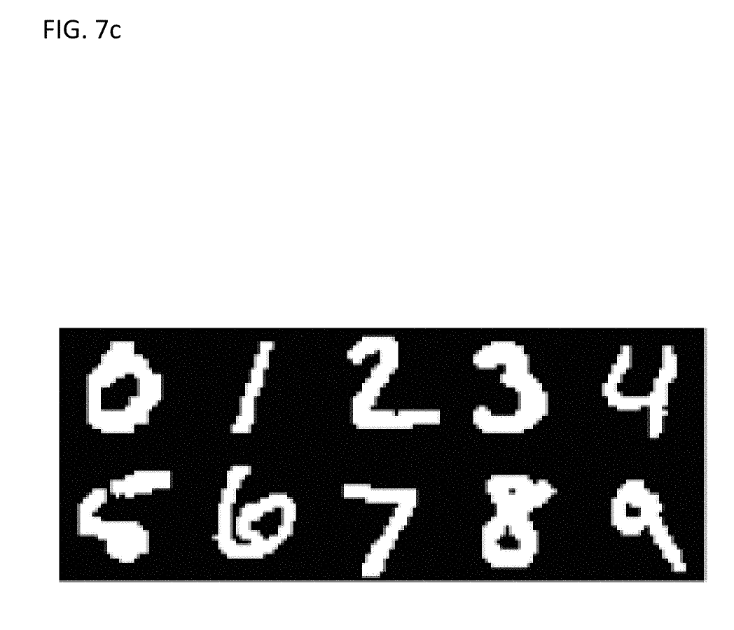

FIGS. 7a to 7c provide an example of such a system in operation, where FIG. 7a shows the real-time robotic tracking from 30-Hz video imagery using 2D bar codes to identify the robots. (CH Hsieh, et al., Proceedings of the 2006 American Control Conference, Minneapolis, Minn., June 14-16, pp 1446-1451). FIG. 7b shows a bar code deconvolution using Wavelet Gizburg-Landau regularizer and the Haar basis. (JA Dobrosotskaya and A L Bertozzi, cited above). Exemplary images from the MNIST database of handwritten digits, in which algorithms have been developed that are capable of automatically sorting images of handwriting with 98% accuracy, are shown in FIG. 7c. It has been shown that performance of these methods exhibits ˜98% accuracy in both semi-supervised (with 3.6% training data) and completely unsupervised settings, either of which may be incorporated into embodiments of the systems and methods. The former runs efficiently and exploits recent advances in spectral analysis of large Hermitian matrices. (As described in C Garcia-Cardona, et al., IEEE Transactions on Pattern Analysis and Machine Intelligence (2014), in press. DOI: 10.1109/TPAMI.2014.2300478; and CR Anderson and A Rayleigh-Chebyshev, Journal of Computational Physics 229, 7477 (2010).) The latter exploits a method from social networking known as modularity optimization in which a problem is reformulated in terms of graph cuts. (See, e.g., H Hu, et al., SIAM Journal of Applied Mathematics 73, 2224 (2013).)

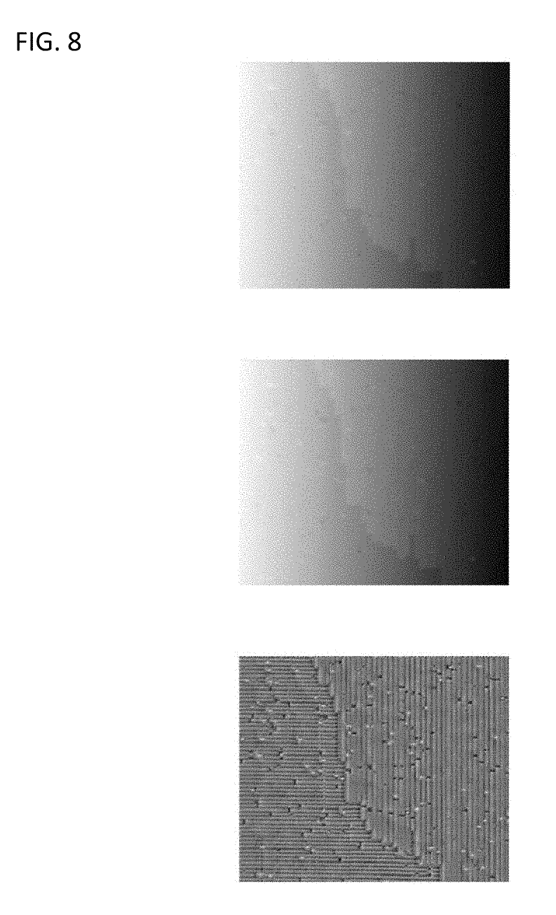

In addition to systems and methods of imaging the patterned nanowires, other embodiments are directed to the tracking, sorting, and identification of these cylindrical striped particles. In some such embodiments the nanowire images are reconstructed and important features extracted. In particular, state-of-the-art reconstruction as well as image decompositions may be incorporated into some embodiments to enhance the images of the striped metal nanorods. In many embodiments one or more of the following methodologies may be used: total variation restoration (LI Rudin, et al., Physica D 60, 259 (1992)); cartoon texture decomposition (L Vese and S Osher, Journal of Scientific Computation 19, 553 (2003); and JE Gilles and S Osher, UCLA CAM Report 11-73, (2011)); and nonlocal TV reconstruction (G Gilboa and S Osher, Multiscale Modeling and Simulation 7, 1005 (2008)). In particular, nonlocal TV reconstruction works well for supervised segmentation determination. In addition, a new cartoon texture decomposition has been developed that may be incorporated into embodiments. FIG. 8 shows the application of this technique to a noisy scanning tunneling microscopy image of silicon and hydrogen atoms. As is shown, the texture that is nearly invisible in the original image is resolved using the technique, thus yielding the positions and identities of individual silicon and hydrogen atoms.

### DOCTRINE OF EQUIVALENTS

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween

What is claimed is:

1. A nanowire probe system comprising:
at least one probe population formed of a plurality of nanowires, the population of nanowires having a distinct imageable pattern associated therewith, the distinct imageable pattern associated with the population being formed on each of the plurality of nanowires of said population; and
wherein the nanowires are comprised of a plurality of segments disposed adjacent each other along the longitudinal axis of the nanowire, the plurality of segments being formed from different materials having an imageable contrast therebetween, the imageable contrast between the different segments forming the imageable pattern.

2. The nanowire probe system of claim 1, comprising at least two probe populations each formed of a plurality of nanowires, each population of nanowires having a distinct imageable pattern associated therewith, the distinct imageable pattern associated with the population being formed on each of the plurality of nanowires of said population.

3. The nanowire probe system of claim 1, wherein the plurality of nanowires in each population are formed of at least two sizes.

4. The nanowire probe system of claim 1, wherein the outer surface of each of the nanowires is functionalized with a plurality of functional groups configured to prevent agglomeration of the nanowires.

5. The nanowire probe system of claim 4, wherein the plurality of functional groups does not obscure the imageable pattern.

6. The nanowire probe system of claim 1, wherein an encapsulation layer is disposed on the outer surface of each of the nanowires, and wherein the encapsulation layer is functionalized with a plurality of functional groups configured to prevent agglomeration of the nanowires.

7. The nanowire probe system of claim 6, wherein the plurality of functional groups and the encapsulation layer do not obscure the imageable pattern.

8. The nanowire probe system of claim 1, wherein the outer surface of each of the nanowires is functionalized with molecular groups to collect content data of a desired chemical species.

9. The nanowire probe system of claim 1, wherein the imageable pattern is identifiable using a video imagery technique selected from the group consisting of computer vision and wavelet-based image processing.

10. The nanowire probe system of claim 1, wherein at least one of the plurality of segments comprises nanoscale structures to reflect desired color patterns.

11. A method of determining reservoir content comprising:
introducing at least one probe population formed of a plurality of nanowires into a fluid medium in at least one fluid reservoir such that a mixture of nanowires and fluid medium is formed within the at least one fluid reservoir, the probe population having a distinct imageable pattern and a functionalized molecular group associated therewith,
wherein the distinct imageable pattern associated with the population being formed on each of the plurality of nanowires of said population, and
wherein the functionalized molecular group associated with the population function to collect content data of a desired chemical species in the at least one fluid reservoir;
obtaining a sample of the mixture from at least one of the at least one fluid reservoir;
imaging the sample;
processing the imaged sample using a signal processor to quantitatively determine the concentration of the at least one probe population disposed within the sample, wherein the concentration of the at least one probe population indicates a flow from the at least one fluid reservoir, and wherein the signal processor is programmed with an automated algorithm and capable of differentiating the distinct imageable patterns associated with each population of nanowires; and
detecting the desired chemical species from the functionalized molecular group associated with the nanowires in the sample.

12. The method of claim 11, further comprising:
introducing at least two probe populations each formed of a plurality of nanowires into a plurality of fluid reservoirs,
wherein each of the at least two probe populations is introduced into a separate fluid reservoir in the plurality of fluid reservoirs such that a mixture of nanowires and fluid medium is formed within each fluid reservoir in the plurality of fluid reservoirs,
wherein each population of nanowires having a distinct imageable pattern associated therewith, the distinct imageable pattern associated with the population being formed on each of the plurality of nanowires of said population;
obtaining a sample of the mixture within each of the plurality of fluid reservoirs;
imaging the samples from each of the plurality of fluid reservoirs; and
processing the imaged samples using a signal processor to quantitatively determine the concentration of each of the at least two probe populations disposed within the samples, wherein the concentration of each of the at least two probe populations indicates a flow from the fluid reservoir in which each of the at least two probe populations was introduced, and wherein the signal processor is programmed with an automated algorithm and capable of differentiating the distinct imageable patterns associated with each population of nanowires.

13. The method of claim 11, wherein the plurality of nanowires in each population are formed of at least two sizes.

14. The method of claim 11, wherein the nanowires are comprised of a plurality of segments disposed adjacent each other along the longitudinal axis of the nanowire.

15. The method of claim 14, wherein at least two of the segments are formed from different materials having an imageable contrast therebetween, the imageable contrast between the different segments forming the imageable pattern.

16. The method of claim 1, wherein the outer surface of each of the nanowires is functionalized with a plurality of functional groups configured to prevent agglomeration of the nanowires.

17. The method of claim 16, wherein the plurality of functional groups do not obscure the imageable pattern.

18. The method claim 11, wherein an encapsulation layer is disposed on the outer surface of each of the nanowires.

19. The method of claim 18, wherein the encapsulation layer is functionalized with a plurality of functional groups configured to prevent agglomeration of the nanowires.

20. The method of claim 19, wherein the encapsulation layer and the plurality of functional groups do not obscure the imageable pattern.

21. The method of claim 11, wherein the imageable pattern is optically imageable and wherein the imaging comprises a video imagery technique selected from the group consisting of computer vision and wavelet-based image processing.

22. The method of claim 11, wherein the processing comprises automatically sorting the images from the sample by a processing technique selected from the group consisting of wavelet Gizburg-Landau regularization, spectral analysis of large Hermitian matrices, and modularity optimization.

23. The method of claim 11, further comprising deconstructing and or reconstructing the imaged mixture sample using an image processing technique selected from the group consisting of total variation restoration, cartoon texture decomposition, and nonlocal TV reconstruction.

24. The method of claim 11, wherein the sampling and imaging occurs within the flow from the at least one fluid reservoir.
